(19) United States
(12) Patent Application Publication
(10) Pub. No.: US 2026/0142412 A1
(43) Pub. Date: May 21, 2026

(54) LEVER-TYPE CONNECTOR

(71) Applicant: SUMITOMO WIRING SYSTEMS, LTD., Mie (JP)

(72) Inventors: Tsuyoshi MASE, Mie (JP); Toshihiro ITO, Mie (JP); Takahiro KIKUCHI, Mie (JP); Yoichi TAKAGI, Mie (JP)

(21) Appl. No.: 19/119,403

(22) PCT Filed: Oct. 10, 2023
(86) PCT No.: PCT/JP2023/036718

§ 371 Date: Apr. 9, 2025

(30) Foreign Application Priority Data
Oct. 12, 2022 (JP) 2022-163710

(51) Int. Cl. H01R 13/629; H01R 13/703

(52) U.S. Cl. CPC H01R 13/62938; H01R 13/6295; H01R 13/703

(57) ABSTRACT

A lever-type connector connectable to a mating connector provided with a mating detection terminal includes a housing, a lever mounted on the housing rotatably between a connection start position and a connection completion position, and a detection terminal held in the housing and configured to form a detection circuit by contacting the mating detection terminal. The housing includes a deflectable and deformable deflecting piece facing the detection terminal. The lever includes a first pressing portion and a second pressing portion for separating the detection terminal from the mating detection terminal by pressing the deflecting piece toward the detection terminal.

### TECHNICAL FIELD

The present disclosure relates to a lever-type connector.

### BACKGROUND

A connector described in Japanese Patent Laid-Open Publication No. 2015-050036 (Patent Document 1 below) is known as a connector capable of connection detection. This connector is provided with a housing connectable to a mating connector, a connection lever supported on the housing, a housing lock for locking the connection lever when connection to the mating connector is completed, and a connection detection terminal for forming a detection circuit by contacting a connection detection terminal of the mating connector. If the rotation of the connection lever is started and an action block provided on the connection lever deflects the housing lock, the connection detection terminal is pressed and deflected and deformed by the housing lock. In this way, the connection detection terminal is disposed at a position separated from the connection detection terminal of the mating connector until the connection lever reaches a connection completion position. When the connection lever reaches the connection completion position, the action block and the housing lock are disengaged and the housing lock returns to a natural state. In this way, the connection detection terminal is restored from the deflected and deformed state and contacts the connection detection terminal of the mating connector.

### PRIOR ART DOCUMENT

### Patent Document

Patent Document 1: JP 2015-050036 A

### SUMMARY OF THE INVENTION

### Problems to be Solved

In the above configuration, since an engaged part of the action block and the housing lock is small, it is difficult to enlarge a rotation angle range of the connection lever in which the connection detection terminal is pressed by the housing lock. Thus, if it is, for example, desired to make an effective contact margin of the connection detection terminal larger, it is necessary to ensure a connection stroke of the connector and the mating connector in a small rotation angle range and it may not be possible to obtain a sufficient effect of reducing a connection force by the connection lever.

### Means to Solve the Problem

The present disclosure is directed to a lever-type connector connectable to a mating connector provided with a mating detection terminal, the lever-type connector being provided with a housing, a lever mounted on the housing rotatably between a connection start position and a connection completion position, and a detection terminal held in the housing, the detection terminal forming a detection circuit by contacting the mating detection terminal, the housing including a deflectable and deformable deflecting piece facing the detection terminal, the lever including a first pressing portion and a second pressing portion for separating the detection terminal from the mating detection terminal by pressing the deflecting piece toward the detection terminal, the first pressing portion starting to press the deflecting piece earlier than the second pressing portion in a rotation process of the lever from the connection start position toward the connection completion position, and pressing of the deflecting piece by the second pressing portion being released and the detection terminal contacting the mating detection terminal when the lever reaches the connection completion position.

### Effect of the Invention

According to the present disclosure, it is possible to provide a lever-type connector facilitating the enlargement of a rotation angle range of a lever in which a detection terminal is deflected and deformed.

### BRIEF DESCRIPTION OF THE DRAWINGS

FIG. 1 is a perspective view of a lever-type connector according to an embodiment and a mating connector.

FIG. 2 is a back view of the lever-type connector and the mating connector.

FIG. 3 is a plan view of the lever-type connector and the mating connector.

FIG. 4 is a perspective view showing a deflecting piece, a first pressing portion and a second pressing portion.

FIG. 5 is a section along A-A of FIG. 3.

FIG. 6 is a view showing a state where a lever is at a connection completion position in a cross-section along A-A of FIG. 3.

FIG. 7 is a section along B-B of FIG. 3.

FIG. 8 is a section along C-C of FIG. 3.

FIG. 9 is a view showing a state where the first pressing portion starts to press the deflecting piece in a cross-section along C-C of FIG. 3.

FIG. 10 is a view showing a state where the lever is rotated toward a connection completion position from the state of FIG. 9 and the first pressing portion is pressing the deflecting piece in the cross-section along C-C of FIG. 3.

FIG. 11 is a view showing a state where the second pressing portion starts to press the deflecting piece at the same rotation angle as in FIG. 10 in a cross-section D-D of FIG. 3.

FIG. 12 is a view showing a state where the lever is rotated toward the connection completion position from the state of FIG. 10 and the first pressing portion is separated from the deflecting piece in the cross-section along C-C of FIG. 3.

FIG. 13 is a view showing a state where the second pressing portion is pressing the deflecting piece at the same rotation angle as in FIG. 12 in the cross-section D-D of FIG. 3.

FIG. 14 is a view showing the state where the lever is at the connection completion position in the cross-section along C-C of FIG. 3.

FIG. 15 is a view showing the state where the lever is at the connection completion position in the cross-section along D-D of FIG. 3.

### DETAILED DESCRIPTION TO EXECUTE THE INVENTION

### [Description of Embodiments of Present Disclosure]

First, embodiments of the present disclosure are listed and described.

(1) The lever-type connector of the present disclosure is connectable to a mating connector provided with a mating detection terminal, and provided with a housing, a lever mounted on the housing rotatably between a connection start position and a connection completion position, and a detection terminal held in the housing, the detection terminal forming a detection circuit by contacting the mating detection terminal, the housing including a deflectable and deformable deflecting piece facing the detection terminal, the lever including a first pressing portion and a second pressing portion for separating the detection terminal from the mating detection terminal by pressing the deflecting piece toward the detection terminal, the first pressing portion starting to press the deflecting piece earlier than the second pressing portion in a rotation process of the lever from the connection start position toward the connection completion position, and pressing of the deflecting piece by the second pressing portion being released and the detection terminal contacting the mating detection terminal when the lever reaches the connection completion position.

According to this configuration, since the deflecting piece is pressed toward the detection terminal by the first pressing portion and the second pressing portion configured to press the deflecting piece later than the first pressing portion, a rotation angle range of the lever in which the detection terminal is pressed is easily enlarged.

(2) Preferably, in the rotation process of the lever from the connection start position toward the connection completion position, the deflecting piece is pressed by the first pressing portion when the second pressing portion starts to press the deflecting piece, and the first pressing portion is separated from the deflecting piece with the deflecting piece pressed by the second pressing portion.

According to this configuration, it can be suppressed that a deflection amount of the deflecting piece largely changes when the second pressing portion starts to press the deflecting piece and when the first pressing portion is separated from the deflecting piece.

(3) Preferably, the deflecting piece is a lock arm, and the second pressing portion includes a locking portion to be locked to the lock arm with the lever located at the connection completion position.

According to this configuration, the deflecting piece and the lock arm may not be separately provided, and the second pressing portion and the locking portion may not be separately provided. Thus, the configuration of the lever-type connector can be simplified.

(4) Preferably, the second pressing portion includes a slide-contact portion in the form of a curved surface and slidable in contact with the deflecting piece.

According to this configuration, the deflection amount of the deflecting piece pressed by the second pressing portion is easily kept constant.

[Details of Embodiment of Present Disclosure]Hereinafter, an embodiment of the present disclosure is described. The present disclosure is not limited to these illustrations, but is represented by claims and intended to include all changes in the scope of claims and in the meaning and scope of equivalents.

### EMBODIMENT

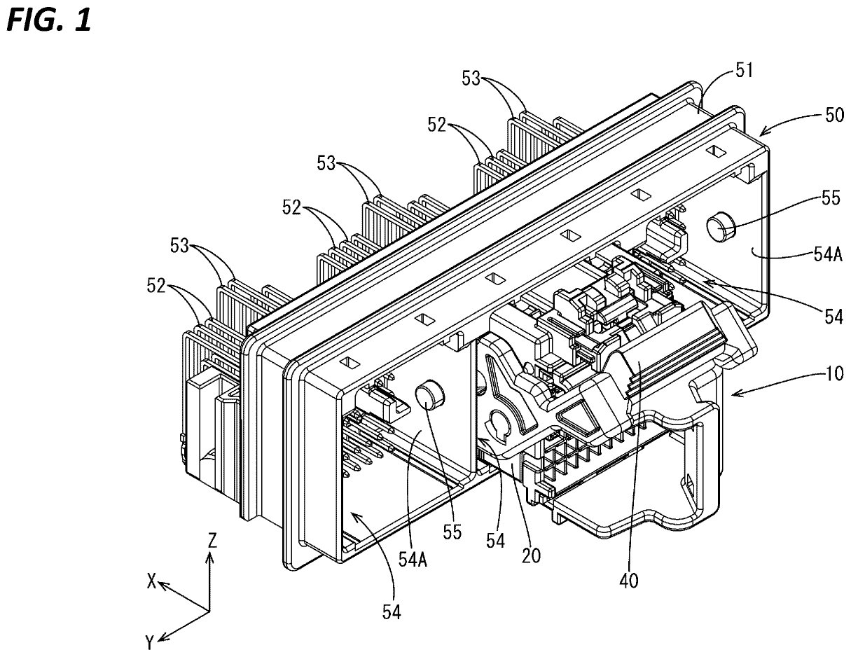

The embodiment of the present disclosure is described with reference to FIGS. 1 to 15. In the following description, a direction indicated by an arrow Z is an upward direction, a direction indicated by an arrow X is a forward direction and a direction indicated by an arrow Y is a leftward direction. Note that, for a plurality of identical members, only some members may be denoted by a reference sing and the other members may be denoted by the reference sign. As shown in FIG. 1, a mating connector 50 connectable to the lever-type connector 10 is a board connector mounted on a circuit board (not shown). In this embodiment, three lever-type connectors 10 are connectable to one mating connector 50. Only the lever-type connector 10 to be fit into a central part of the mating connector 50 is shown in figures.

### [Mating Connector]

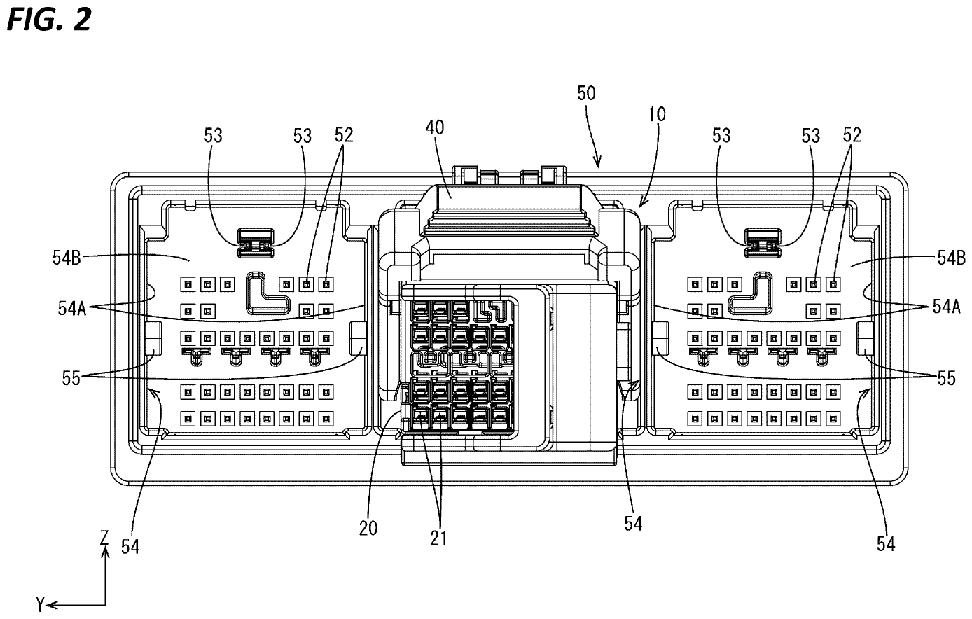

The mating connector 50 is provided with a mating housing 51 and a plurality of mating terminals 52 and a plurality of mating detection terminals 53 held in the mating housing 51. The mating housing 51 is made of synthetic resin and has a laterally long rectangular shape as a whole. As shown in FIGS. 1 and 2, the mating housing 51 is provided with a plurality of fitting recesses 54, into which the lever-type connectors 10 are fittable. A pair of cam pins 55 are provided on both side walls 54A constituting both left and right sides of the fitting recess 54. The pair of cam pins 55 are provided with one on each side wall 54A, and bilaterally symmetrically disposed. The cam pin 55 is formed into a cylindrical shape.

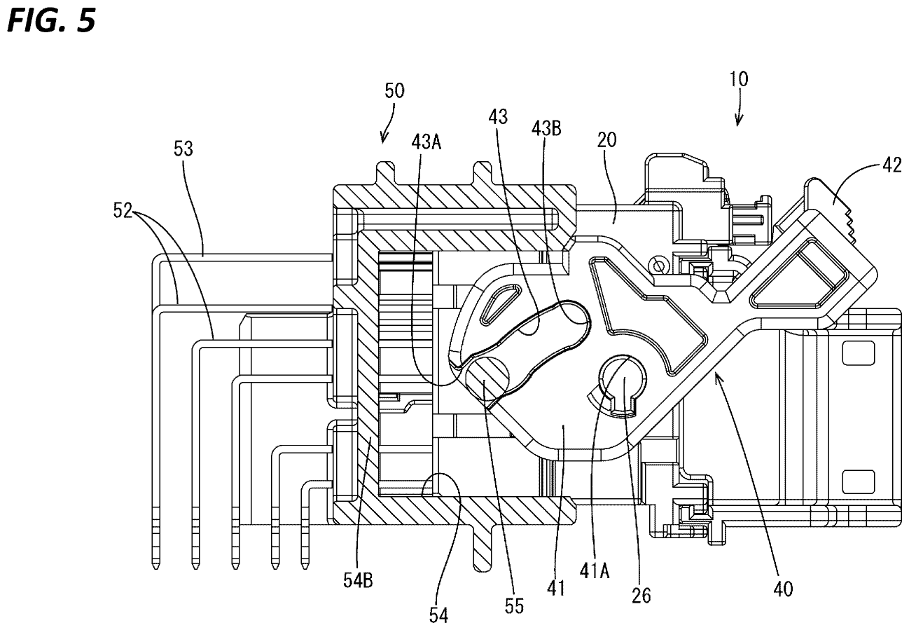

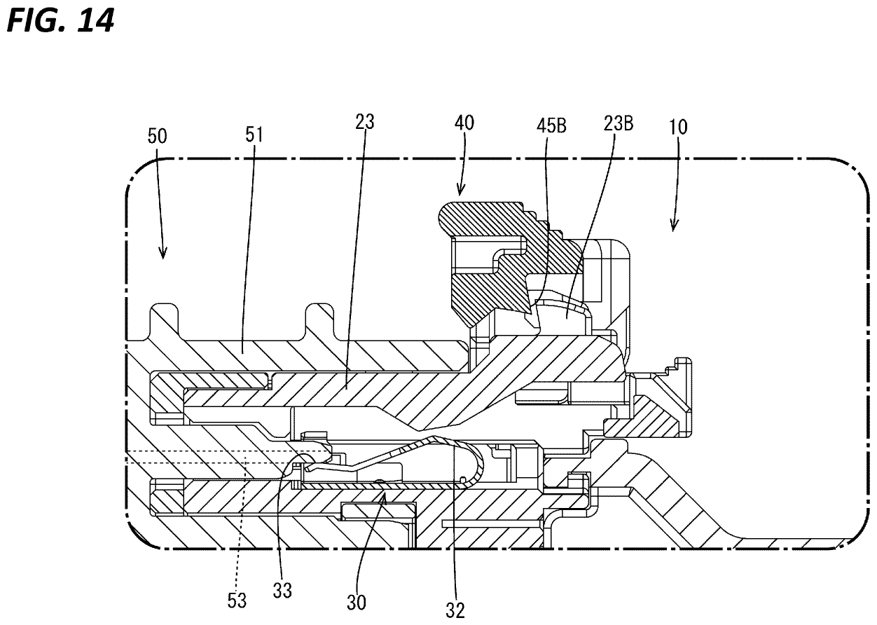

As shown in FIG. 5, the mating terminals 52 and the mating detection terminals 53 are constituted by needle-like terminals made of metal, and held on a back wall 54B constituting the fitting recess 54 while being passed through the back wall 54B in a front-rear direction. One end of each of the mating terminals 52 and the mating detection terminals 53 projects into the fitting recess 54 from the back wall 54B and extends in the front-rear direction. The other end of each of the mating terminals 52 and the mating detection terminals 53 is disposed outside the fitting recess 54 and bent downward. The mating detection terminals 53 are electrically connected to a detection terminal 30 provided in the lever-type connector 10 as the mating connector 50 and the lever-type connector 10 are properly connected (see FIG. 14).

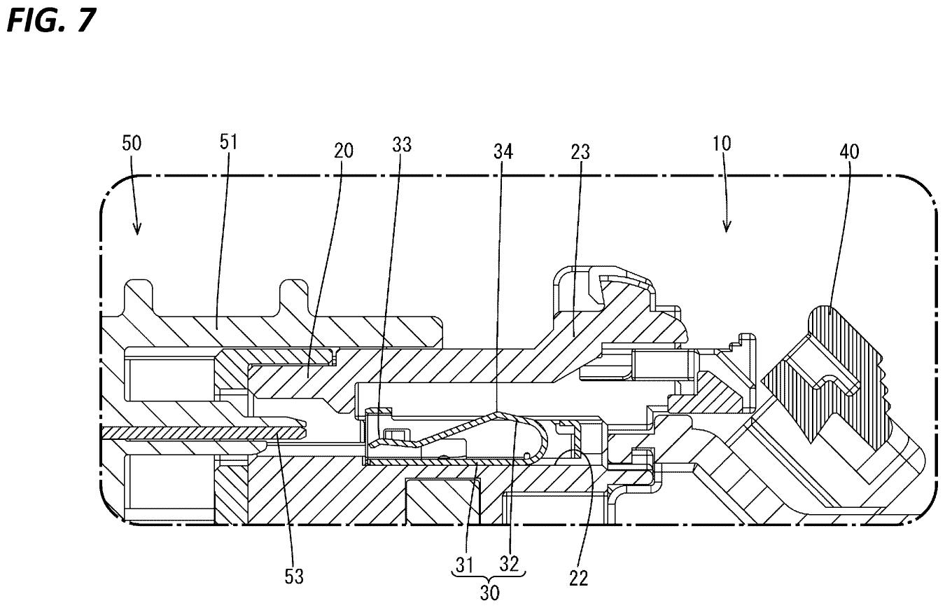

FIG. 7 is a section and, therefore, shows only one mating detection terminal 53. However, as shown in FIGS. 1 and 2, the mating housing 51 holds two mating detection terminals 53 at an interval in a width direction in one fitting recess 54. The two mating detection terminals 53 are connected to a detection circuit of a device. The two mating detection terminals 53 are not electrically connected until being contacted by the detection terminal 30 of the lever-type connector 10, but a detection circuit is formed if the detection terminal 30 contacts both of the two mating detection terminals 53.

### [Lever-type Connector]

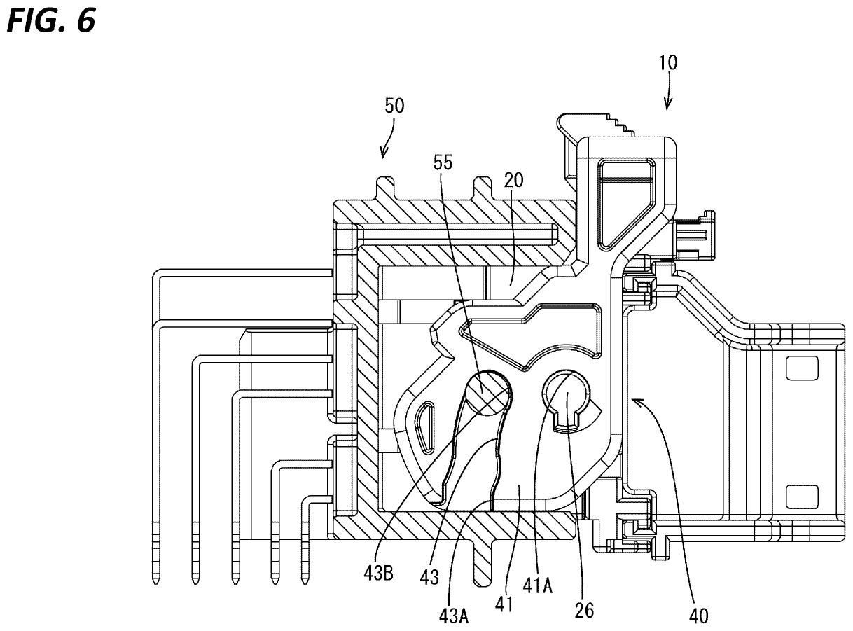

The lever-type connector 10 is, as shown in FIG. 1, provided with a housing 20, a plurality of terminals (not shown), the detection terminal 30 (see FIG. 7) and a lever 40. The terminal is a female terminal and connected to the mating terminal 52. The lever 40 is rotatable between a connection start position shown in FIG. 5 and a connection completion position shown in FIG. 6. The lever-type connector 10 is fit into the mating connector 50 if the lever 40 is moved from the connection start position to the connection completion position, and the lever-type connector 10 is separated from the mating connector 50 if the lever 40 is conversely moved from the connection completion position to the connection start position.

### [Housing]

The housing 20 is made of synthetic resin and, as shown in FIG. 2, in the form of a substantially rectangular block. The housing 20 is provided with terminal accommodating portions 21 penetrating in the front-rear direction to accommodate the terminals. As shown in FIG. 7, the housing 20 is provided with a detection terminal accommodating portion 22 penetrating in the front-rear direction to accommodate the detection terminal 30. The detection terminal accommodating portion 22 is disposed on an upper side and in a lateral central part of the housing 20.

### [Deflecting Piece]

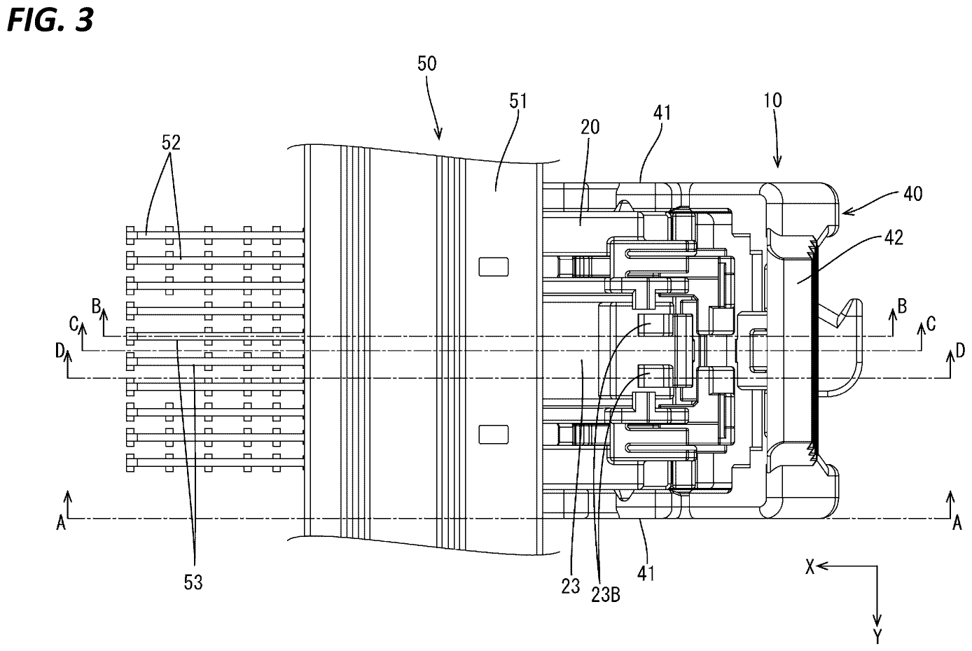

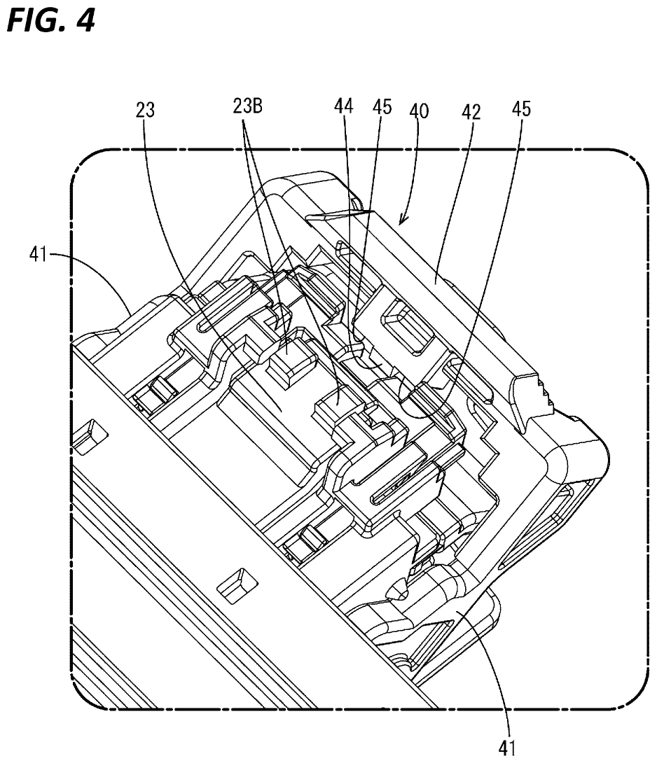

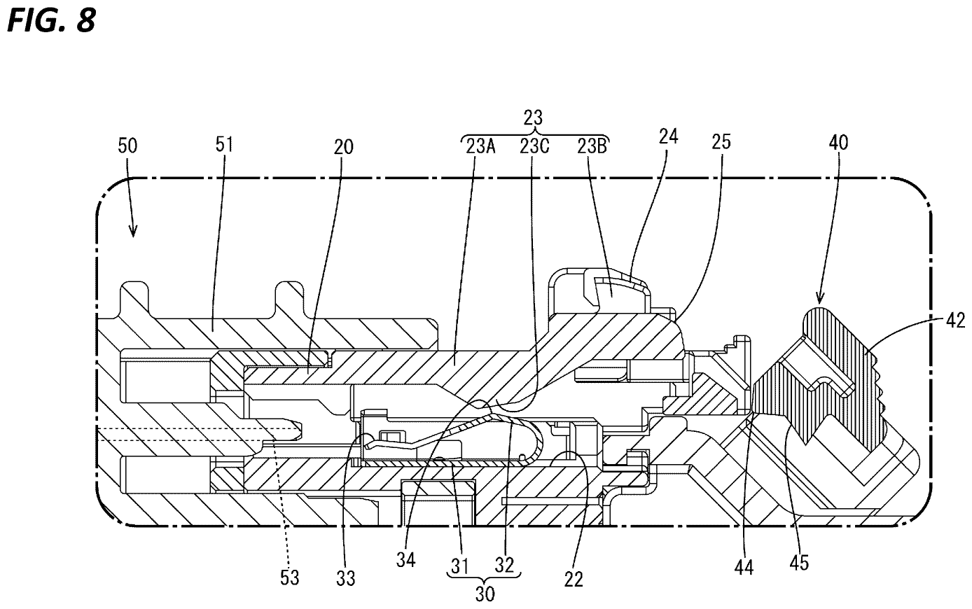

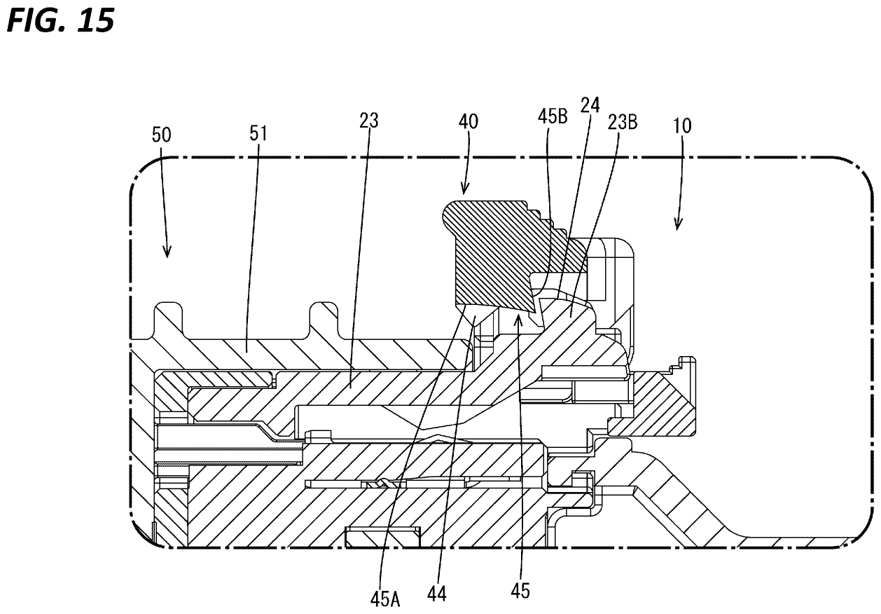

As shown in FIG. 8, the housing 20 is provided with a deflecting piece 23 extending rearward from the upper wall of the housing 20. The deflecting piece 23 is provided to be deflectable and deformable in the vertical direction with a front end part connected to the upper wall of the housing 20 as a base end. The deflecting piece 23 of this embodiment is a lock arm. The deflecting piece 23 includes a deflecting piece body 23A and fitting lock portions 23B projecting upward from a rear part of the deflecting piece body 23A. As shown in FIGS. 3 and 4, the deflecting piece 23 of this embodiment is provided with two fitting lock portions 23B at an interval in the lateral direction. The fitting lock portions 23B are locked to a locking portion 45B provided on the lever 40 with the lever-type connector 10 and the mating connector 50 properly connected (see FIG. 15).

As shown in FIG. 8, the upper surface of the fitting lock portion 23B serves as a sliding contact portion 24 in the form of a curved surface convex upward. A press starting portion 25 having a rounded shape is provided on an upper part of a rear end part of the deflecting piece 23.

The deflecting piece 23 is disposed to partition an upper part of the detection terminal accommodating portion 22. The deflecting piece 23 is provided with a projection 23C projecting into the detection terminal accommodating portion 22 from the deflecting piece body 23A. By deflecting and deforming the deflecting piece 23 downward, the projection 23C presses the detection terminal 30.

### [Detection Terminal]

The detection terminal 30 is formed, such as by bending an electrically conductive metal plate into a predetermined shape, and includes a base plate portion 31 disposed along the lower inner surface of the detection terminal accommodating portion 22 and a spring portion 32 bent into a predetermined shape by being folded forward from the rear end of the base plate portion 31. The spring portion 32 includes contact point portions 33 disposed near a front end part of the spring portion 32 and an engaging portion 34 disposed in a rear part of the spring portion 32. The contact point portions 33 and the engaging portion 34 are bent into a chevron shape projecting upward. The spring portion 32 is forked on a tip side (front end side) and a pair of left and right contact point portions 33 are provided.

As shown in FIG. 14, if the lever-type connector 10 and the mating connector 50 are properly connected, each contact point portion 33 contacts the mating detection terminal 53. In this way, the two mating detection terminals 53 are electrically connected to the detection terminal 30 to form the detection circuit.

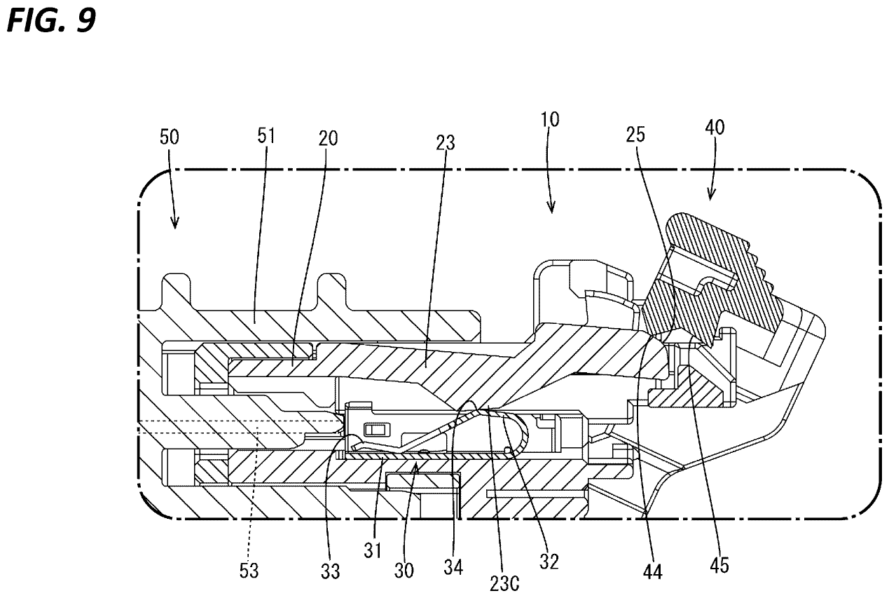

As shown in FIG. 9, the engaging portion 34 is pressed by the projection 23C of the deflecting piece 23. The engaging portion 34 is pressed by the projection 23C, whereby the contact point portions 33 are displaced toward the base plate portion 31.

As shown in FIGS. 5 and 6, a pair of rotary shafts 26 projecting outwardly of the housing 20 in the lateral direction are provided on both side surfaces of the housing 20. The pair of rotary shafts 26 are provided with one on each side surface and bilaterally symmetrically disposed.

### [Lever]

The lever 40 is rotatably supported on the housing 20 and functions as a booting mechanism by being operated when the lever-type connector 10 is connected to and separated from the mating connector 50. The lever 40 rotates in a range from the connection start position shown in FIG. 5 to the connection completion position shown in FIG. 6. That is, if the lever 40 is rotated counterclockwise from the connection start position to the connection completion position, the lever-type connector 10 is properly connected to the mating connector 50.

The lever 40 is made of synthetic resin. As shown in FIGS. 3 and 4, the lever 40 is provided with a pair of cam plates 41 and an operating portion 42 coupling tip parts of the pair of cam plates 41 to each other, and gate-shaped as a whole.

As shown in FIGS. 5 and 6, each cam plate 41 is formed with a shaft hole 41A penetrating through the cam plate 41. The rotary shafts 26 are inserted into the shaft holes 41A. The lever 40 is supported on the housing 20 rotatably around the rotary shafts 26.

The cam plate 41 includes a track 43, into which the cam pin 55 enters. The track 43 includes an entrance 43A open forward on the outer edge of the cam plate 41, and is formed to approach the shaft hole 41A from the entrance 43A toward a final end 43B. If the lever-type connector 10 and the mating connector 50 are lightly connected when the lever 40 is at the connection start position, the cam pins 55 enter the entrances 43 A of the tracks 43 as shown in FIG. 5.

If the lever 40 is moved from the connection start position to the connection completion position, the cam pins 55 are engaged with the inner walls of the tracks 43, whereby the connection of the lever-type connector 10 and the mating connector 50 proceeds. When the lever 40 is at the connection completion position, the cam pins 55 are located at the final ends 43B of the tracks 43 as shown in FIG. 6. Conversely, if the lever 40 is moved from the connection completion position to the connection start position, the cam pins 55 are engaged with the inner walls of the tracks 43, whereby the separation of the lever-type connector 10 and the mating connector 50 proceeds.

### [First Pressing Portion, Second Pressing Portion]

As shown in FIG. 8, the lever 40 is provided with a second pressing portion 45 projecting inward in a rotation radial direction from the operating portion 42 and a first pressing portion 44 projecting further inward in the rotation radial direction from the second pressing portion 45. Here, the rotation radial direction is a direction orthogonal to an extension direction of the rotary shafts 26 (lateral direction) and passing through a center of rotation, and a direction toward the rotary shafts 26 is referred to as an inward direction and a direction away from the rotary shafts 26 is referred to as an outward direction. As shown in FIG. 4, the second pressing portion 45 is disposed in a lateral central part of the operating portion 42. The first pressing portion 44 is smaller than the second pressing portion 45 in the lateral direction and disposed in a lateral central part of the second pressing portion 45.

### [Slide-Contact Portion, Locking Portion]

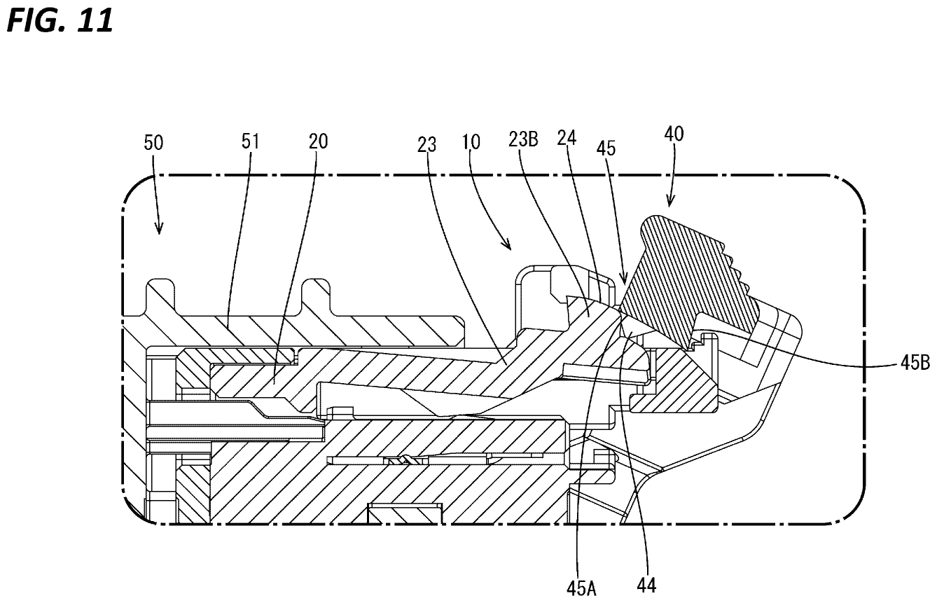

As shown in FIG. 11, the second pressing portion 45 includes a slide-contact portion 45A in the form of a curved surface. The slide-contact portion 45A is in the form of an arc, which is a part of a circle, substantially centered on the rotary shafts 26 in a side view. As shown in FIG. 15, the rear end surface of the second pressing portion 45 serves as the locking portion 45B on the basis of the posture of the lever 40 at the connection completion position. With the lever-type connector 10 and the mating connector 50 properly connected, the locking portion 45B is disposed to face the fitting lock portions 23B and the locking portion 45B and the fitting lock portions 23B are locked, whereby the lever 40 is restricted from rotating in a separation direction.

The first pressing portion 44 has a chevron shape projecting from the slide-contact portion 45A. That is, the first pressing portion 44 is provided on a front side part of the slide-contact portion 45A on the basis of the posture of the lever 40 at the connection completion position.

### [Pressing of Deflecting Piece by First and Second Pressing Portions]

Next, a process of pressing the deflecting piece 23 by the first and second pressing portions 44, 45 when the lever-type connector 10 is connected to the mating connector 50 is described.

The lever-type connector 10 is positioned with respect to the mating connector 50 and the housing 20 is inserted into the fitting recess 54 (see FIGS. 1 and 5). In a shallow insertion stage before the start of a connecting operation, the lever 40 is separated from the deflecting piece 23 as shown in FIGS. 7 and 8, wherefore the deflecting piece 23 and the detection terminal 30 are in a natural state. Further, the detection terminal 30 and the mating detection terminals 53 are separated in a connection direction (front-rear direction).

With the cam pins 55 located in the entrances 43 A of the tracks 43, the operating portion 42 is operated and the lever 40 is rotated from the connection start position to the connection completion position. As shown in FIG. 9, the first pressing portion 44 of the lever 40 contacts the press starting portion 25 of the deflecting piece 23. In this way, the deflecting piece 23 is deflected and deformed downward. Then, the projection 23C of the deflecting piece 23 presses the engaging portion 34 of the detection terminal 30 to deflect and deform the spring portion 32 downward.

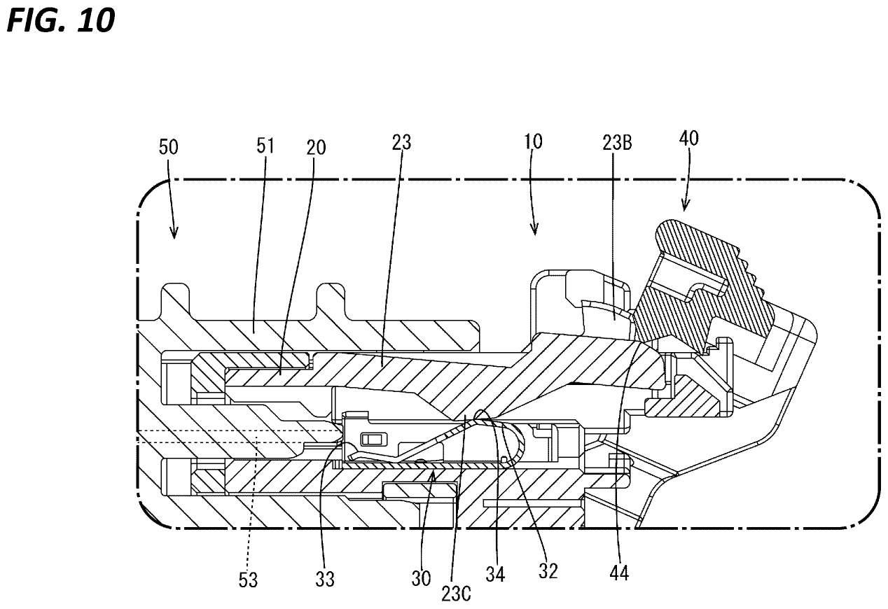

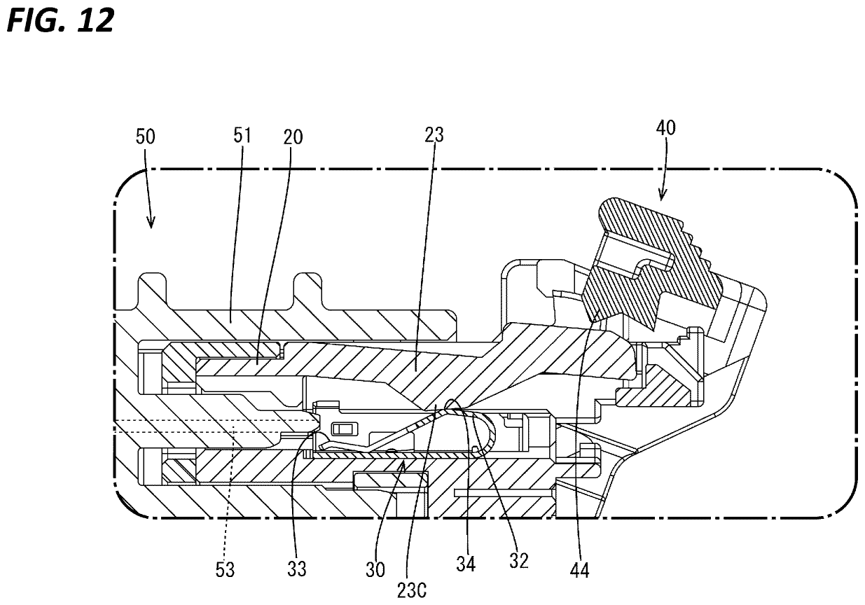

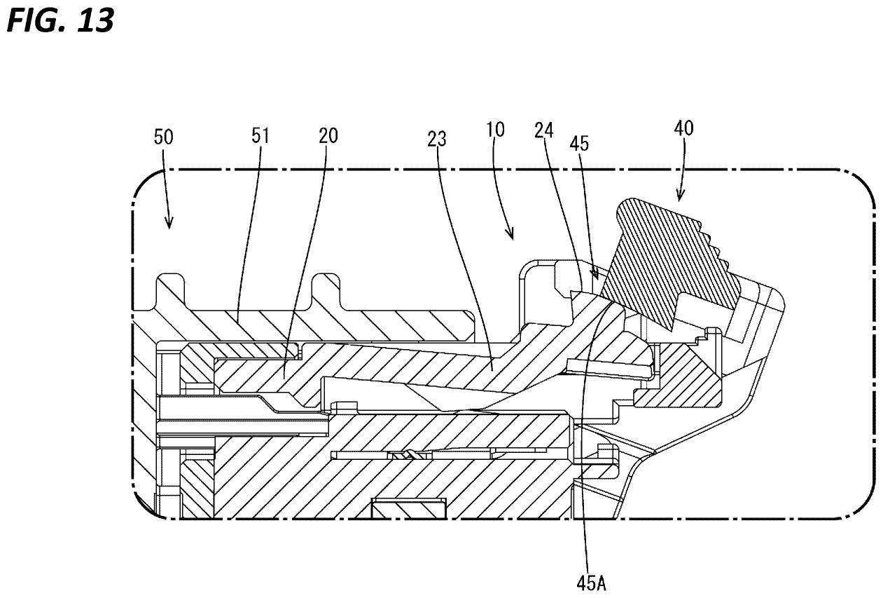

If the lever 40 is further rotated, the first pressing portion 44 enters a gap between the two fitting lock portions 23B while pressing the deflecting piece 23 as shown in FIG. 10. Then, as shown in FIG. 11, the slide-contact portion 45A of the second pressing portion 45 starts to slide in contact with the sliding contact portions 24 of the fitting lock portions 23B. If the lever 40 is further rotated, the first pressing portion 44 is separated from the deflecting piece 23 (see FIG. 12) with the slide-contact portion 45A held in sliding contact with the sliding contact portions 24 (see FIG. 13).

Note that tip parts of the mating detection terminals 53 reach positions overlapping the detection terminal 30 in the front-rear direction in a process from the state of FIG. 10 to the state of FIG. 12. However, since the spring portion 32 is pressed by the projection 23C of the deflecting piece 23 and the contact point portions 33 are pushed down to positions lower than the mating detection terminals 53, the detection terminal 30 and the mating detection terminals 53 do not contact.

As described above, both the first and second pressing portions 44, 45 press the deflecting piece 23 in a predetermined rotation angle range (see FIG. 11) in this embodiment. In this way, when the second pressing portion 45 contacts the deflecting piece 23 and when the pressing of the deflecting piece 23 by the first pressing portion 44 is released, it is easily suppressed that a deflection amount of the deflecting piece 23 largely changes.

If the lever 40 is further rotated, the connection of the lever-type connector 10 and the mating connector 50 proceeds with the slide-contact portion 45A held in sliding contact with the sliding contact portions 24. Here, since the slide-contact portion 45A and the sliding contact portions 24 are in the form of curved surfaces, the deflection amount of the deflecting piece 23 is easily maintained substantially constant.

When the lever 40 reaches the connection completion position, the slide contact of the slide-contact portion 45A and the sliding contact portions 24 is released and the deflecting piece 23 returns to the natural state as shown in FIG. 15. In this way, the locking portion 45B of the second pressing portion 45 and the fitting lock portions 23B of the deflecting piece 23 are disposed to be lockable. By locking the locking portion 45B and the fitting lock portions 23B, the rotation of the lever 40 from the connection completion position to the connection start position is suppressed. Further, as shown in FIG. 14, the spring portion 32 also resiliently returns to an initial position and the contact point portions 33 contact the mating detection terminals 53 as the deflecting piece 23 resiliently returns. Since the detection circuit is formed by the detection terminal 30 and the mating detection terminals 53 in this way, the proper connection of the mating connector 50 and the lever-type connector 10 can be confirmed through the electrical conduction of the both.

As described above, since the first and second pressing portions 44, 45 are provided in this embodiment, the lever 40 can be rotated with the pressing of the deflecting piece 23 by the second pressing portion 45 continued even if a rotation angle at which the first pressing portion 44 is separated from the deflecting piece 23 is reached. Thus, the deflecting piece 23 can continue to be pressed in a wide rotation angle range as compared to the case where only one pressing portion is provided. Thus, the lever-type connector 10 and the mating connector 50 can be connected in a large rotation angle range, wherefore an effective contact margin of the detection terminal 30 and the mating detection terminals 53 is easily ensured. Further, an effect of reducing a connection force by the lever 40 is easily obtained.

### [Functions and Effects of Embodiment]

According to the embodiment, the following functions and effects are achieved. The lever-type connector 10 according to the embodiment is connectable to the mating connector 50 provided with the mating detection terminals 53, and provided with the housing 20, the lever 40 rotatably mounted on the housing 20 between the connection start position and the connection completion position, and the detection terminal 30 held in the housing 20 and configured to form the detection circuit by contacting the mating detection terminals 53. The housing 20 is provided with the deflectable and deformable deflecting piece 23 facing the detection terminal 30. The lever 40 is provided with the first pressing portion 44 and the second pressing portion 45 for separating the detection terminal 30 from the mating detection terminals 53 by pressing the deflecting piece 23 toward the detection terminal 30. In the process of rotating the lever 40 from the connection start position toward the connection completion position, the first pressing portion 44 starts to press the deflecting piece 23 earlier than the second pressing portion 45, and the pressing of the deflecting piece 23 by the second pressing portion 45 is released and the detection terminal 30 contacts the mating detection terminals 53 when the lever 40 reaches the connection completion position.

According to this configuration, since the deflecting piece 23 is pressed toward the detection terminal 30 by the first pressing portion 44 and the second pressing portion 45 for pressing the deflecting piece 23 later than the first pressing portion 44, the rotation angle range of the lever 40 in which the detection terminal 30 is pressed is easily enlarged.

In this embodiment, when the second pressing portion 45 starts to press the deflecting piece 23 in the process of rotating the lever 40 from the connection start position toward the connection completion position, the deflecting piece 23 is pressed by the first pressing portion 44 and the first pressing portion 44 is separated from the deflecting piece 23 with the deflecting piece 23 pressed by the second pressing portion 45.

According to this configuration, it can be suppressed that the deflection amount of the deflecting piece 23 largely changes when the second pressing portion 45 starts to press the deflecting piece 23 and when the first pressing portion 44 is separated from the deflecting piece 23.

In the embodiment, the deflecting piece 23 is a lock arm, and the second pressing portion 45 includes the locking portion 45B to be locked to the lock arm with the lever 40 located at the connection completion position.

According to this configuration, the deflecting piece 23 and the lock arm may not be separately provided, and the second pressing portion 45 and the locking portion 45B may not be separately provided. Thus, the configuration of the lever-type connector 10 can be simplified.

In the embodiment, the second pressing portion 45 includes the slide-contact portion 45A in the form of a curved surface and slidable in contact with the deflecting piece 23.

According to this configuration, the deflection amount of the deflecting piece pressed by the second pressing portion 45 is easily kept constant.

### <Other Embodiments>

(1) Although the mating connector 50 is provided with the three fitting recesses 54 in the above embodiment, there is no limitation to this and the number of fitting recess(es) of a mating connector may be one, two, four or more.

(2) Although the first pressing portion 44 projects from the second pressing portion 45 in the above embodiment, there is no limitation to this and a first pressing portion and a second pressing portion may not be provided to be continuous with each other or the relative arrangement of the first and second pressing portions may be changed as appropriate.

(3) Although the lock arm includes two fitting lock portions 23B in the above embodiment, there is no limitation to this and, for example, one fitting lock portion may be provided.

(4) Although both the first pressing portion 44 and the second pressing portion 45 press the deflecting piece 23 in the predetermined rotation angle range in the above embodiment, there is no limitation to this. For example, after a first pressing portion is separated from a deflecting piece in the process of rotating a lever from a connection start position toward a connection completion position, a second pressing portion may start to press the deflecting piece. In this case, the deflecting piece is preferably set not to completely return to a natural state until the second pressing portion starts to press the deflecting piece after the first pressing portion is separated from the deflecting piece.

### LIST OF REFERENCE NUMERALS

10: lever-type connector
20: housing
21: terminal accommodating portion
22: detection terminal accommodating portion
23: deflecting piece
23A: deflecting piece body
23B: fitting lock portion
23C: projection
24: sliding contact portion
25: press starting portion
26: rotary shaft
30: detection terminal
31: base plate portion
32: spring portion
33: contact point portion
34: engaging portion
40: lever
41: cam plate
41A: shaft hole
42: operating portion
43: track
43A: entrance
43B: final end
44: first pressing portion
45: second pressing portion
45A: slide-contact portion
45B: locking portion
50: mating connector
51: mating housing
52: mating terminal
53: mating detection terminal
54: fitting recess
54A: side wall
54B: back wall
55: cam pin

1. A lever-type connector connectable to a mating connector provided with a mating detection terminal, comprising:
a housing;
a lever mounted on the housing rotatably between a connection start position and a connection completion position; and
a detection terminal held in the housing, the detection terminal forming a detection circuit by contacting the mating detection terminal,
the housing including a deflectable and deformable deflecting piece facing the detection terminal,
the lever including a first pressing portion and a second pressing portion for separating the detection terminal from the mating detection terminal by pressing the deflecting piece toward the detection terminal,
the first pressing portion starting to press the deflecting piece earlier than the second pressing portion in a rotation process of the lever from the connection start position toward the connection completion position, and
pressing of the deflecting piece by the second pressing portion being released and the detection terminal contacting the mating detection terminal when the lever reaches the connection completion position.

2. The lever-type connector of claim 1, wherein, in the rotation process of the lever from the connection start position toward the connection completion position,
the deflecting piece is pressed by the first pressing portion when the second pressing portion starts to press the deflecting piece, and
the first pressing portion is separated from the deflecting piece with the deflecting piece pressed by the second pressing portion.

3. The lever-type connector of claim 1 wherein:
the deflecting piece is a lock arm, and
the second pressing portion includes a locking portion to be locked to the lock arm with the lever located at the connection completion position.

4. The lever-type connector of claim 1, wherein the second pressing portion includes a slide-contact portion in the form of a curved surface and slidable in contact with the deflecting piece.
